(19) United States
(12) Patent Application Publication
(10) Pub. No.: US 2008/0028003 A1
(43) Pub. Date: Jan. 31, 2008

(54) Structured object model merge tool with static integrity constraint observance

(76) Inventor: Thomas Brueggemann, Mannheim (DE)

Correspondence Address: MINTZ, LEVIN, COHN, FERRIS, GLOVSKY AND POPEO, P.C, LA JOLLA CENTRE II, 9255 TOWNE CENTRE DRIVE, SUITE 600, SAN DIEGO, CA, 92121-3039, US

(21) Appl. No.: 11/495,286

(22) Filed: Jul. 28, 2006

(51) Int. Cl. G06F 17/30

(52) U.S. Cl. 707/202

(57) ABSTRACT

An object-based merge tool for structured object models encapsulates data in files, such as metadata in XML files, as model objects in accordance with an underlying model, all of which can be graphically represented to a user. Graphical representation of files also allows the user to see how the files have been changed and allow for the observation of static integrity constraints. The differences between files or file sets can be graphically represented to the user, such as through markings of the model objects in the tree structure, and the differences can be explained in an additional view. Related apparatus, computer program products and computer systems are also described.

### BACKGROUND

The subject matter described herein relates to object-based merge tools for handling merge scenarios that observe static integrity constraints.

Extensible mark-up language (XML) files that contain metamodel-based metadata often require special treatment during merge scenarios, which typically occur during team development scenarios (e.g., check-in conflicts) or during upgrades of modified systems (e.g., integration conflicts). A check-in conflict may exist when two users work on a file or file set separately, then check-in their changed or unchanged versions into, e.g., a design time repository (DTR) versioning system. The merging of these two versions of the original (or ancestor) file or file set creates a check-in conflict. An integration conflict may exist when a file or file set is released, but further development of the file or file set occur internally for the next release, while the file or file set that was released is modified. Then the next release of the file or file set occurs. In this case, the merging of these two different releases is simply an upgrade of a modified system and creates an integration conflict. In particular, the upgrade of modified systems on the customer side generally requires comprehensive tool support to reduce the complexity of the merge scenario and to help rule out inconsistencies caused during the merge operation.

Existing merge tools are text-based, which when used with XML files, are difficult to use and are not useful to prevent inconsistencies during a merge scenario. That is, existing merge tools are generally only capable of providing a textual representation of the differences in the metadata between XML files, which generally requires a user to still read the content of the XML file to determine the differences. Existing merge tools also do not provide any connection to a meta-model and/or to a versioning system. Moreover, existing merge tools do not adequately allow for the observance of static integrity constraints during a merge process.

### SUMMARY

The present inventors recognized that existing merge tools are text-based, which when used with XML files, are difficult to use and do not prevent inconsistencies during a merge operation and do not provide any connection to a meta-model and/or to a versioning system. Consequently, the present inventors developed the subject matter described herein, e.g., an object-based merge tool, that is intuitive and easy to use. The object-based merge tool encapsulates metadata in XML files as model objects in accordance with an underlying metamodel, all of which can be graphically represented to the user. The model objects may be formed in a tree structure (or any other structure), which makes the semantical structure of the XML files clear to the user and easily understandable by the user. Additionally, with the graphical representation of the XML files (with their metamodel and model objects formed in a tree structure, for example), a user is able to see how the files have been changed. The differences between XML files or file sets can be graphically represented to the user, such as through markings of the model objects in the tree structure, and the differences can be explained in an additional view.

For each difference delta between two files versions or file set versions, a user may decide which version he wants to have in the resulting file or file set. Sometimes semantical issues force uniform handling of multiple difference deltas. For the sake of semantical correctness, a merge tool ordinarily should not allow the independent handling of these deltas. Such deltas should be presented to users as a single delta. Groups of different deltas are referred to herein as ‘transactional units’.

In one aspect, at least two transactional units can be identified during a merging of at least two versions of a file. Such transactional units can include members that requiring uniform handling to avoid violation of one or more static integrity constraints. Thereafter, user-generated input can be received that selects one of the transactional units in a first version of the file which can result in the members of the selected transactional unit being copied to a second version of the file.

In some variations, differences that require uniform handling to form a transactional unit can be identified (e.g., visually displayed in a distinctive format, etc.). In addition, a graphical user interface can provide that each member of a transactional unit in response to user-generated input (e.g., activation of a button, etc.).

Members of a transactional unit that are associated with a conflict can be displayed in a distinctive visual format. In addition, information characterizing conflicts can be displayed in order to provide a user with useful information (e.g., attributes, etc.). prior to completing a merge operation.

Computer program products, which may be embodied on computer readable-material, are also described. Such computer program products may include executable instructions that cause a computer system to conduct one or more of the method acts described herein.

Similarly, computer systems are also described that may include a processor and a memory coupled to the processor. The memory may encode one or more programs that cause the processor to perform one or more of the method acts described herein.

The subject matter described herein may provide one or more of the following advantages. The object-based merge tool provides an abstract and graphical view of the metadata of XML files or file sets to provide a better and more intuitive presentation of the differences between XML files. This view will aid in resolving the differences (i.e. conflict resolution) during team development (i.e., concurrent work on the same application metadata) and upgrades to modified systems. Furthermore, the object-based merge tool can support two-way and three-way merge scenarios and interact with a DTR versioning system.

The details of one or more implementations are set forth in the accompanying drawings and the description below. Other features and advantages will be apparent from the description and drawings, and from the claims.

### DESCRIPTION OF DRAWINGS

FIG. 1 is a flow diagram depicting a process of observing static integrity constraints during a merge process.

FIG. 2 is a flow diagram depicting a process for graphically representing a file containing metadata.

FIG. 3 is a flow diagram depicting an interrelated process for graphically representing a file containing metadata.

FIG. 4 depicts an example of a graphical user interface that can result from the processes of FIGS. 2 and 3.

FIG. 5 is a flow diagram depicting a process for graphically representing differences between the content of files containing metadata for use during a merge process

FIG. 6 is a flow diagram depicting a process for merging files containing metadata.

FIG. 7 depicts a graphical user interface of a merge tool frame work that can be used to merge files or file sets containing metadata.

FIG. 8 is a block diagram of the architecture of a merge tool framework that can be used to merge files or file sets containing metadata.

FIG. 9 depicts a first view of a graphical user interface of a merge tool observing static integrity constraints.

FIG. 10 depicts a first view of a graphical user interface of a merge tool observing static integrity constraints.

FIG. 11 depicts a first view of a graphical user interface of a merge tool observing static integrity constraints.

Like reference symbols in the various drawings indicate like elements.

### DETAILED DESCRIPTION

FIG. 1 is a flow diagram depicting an implementation of a process 100 for observing static integrity constraints in connection with a merge process. At least two transactional units, are identified, at 10, during a merging of at least two versions of a file. Such transactional units include members requiring uniform handling to avoid violation of one or more static integrity constraints. Thereafter, at 120, user-generated input selecting one of the transactional units in a first version of the file is received. In response to the user-generated input, at 130, the members of the selected transactional unit are copied to a second version of the file.

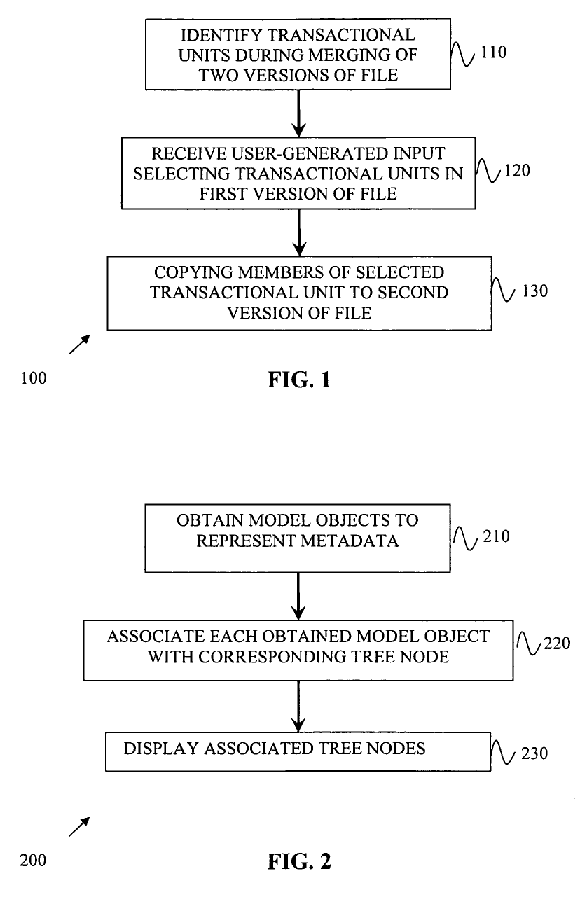

FIG. 2 is a flow diagram depicting an implementation of a process 200 for graphically representing a file (or file set) containing model-based metadata. The file may be, for example, a picture, diagram, text document or programming code, and may contain data other than model-based metadata. As used herein, a model may be considered any structure of model objects (or entities) of information, which may be arbitrarily connected. The model, in this implementation, results from the content of the file (or file set), such as the metadata, and the file (or file set) may be retrieved from a DTR or local hard disk.

With continued reference to FIG. 2, at 210, model objects to represent metadata are obtained. In this implementation, there is a root model object that all other model objects can be reachable from. Furthermore, each model object may have a set of property-value pairs assigned The set of properties (or attributes) may include, for example, type, codebody, and visibility, or any other suitable properties needed to represent the metadata associated with the model object. The value assigned to a particular property may be user-defined. For example, the value assigned to the property named “visibility” may be “public” or “private”. At 220, each model object is associated with a corresponding tree node. At 230, the tree nodes are displayed so that the content of the file is graphically represented as a tree structure. As such, the result of process 200 is a semantical structure of the file content, which is clear and easily understandable to a user compared to reading the contents of the file directly to determine the content structure of the file.

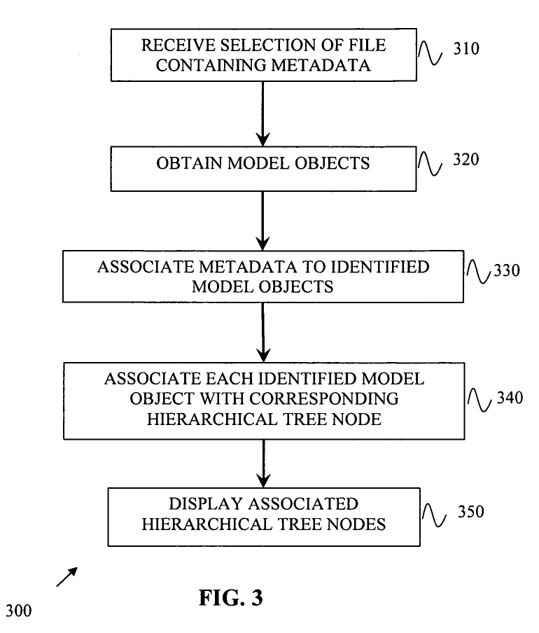

FIG. 3 is a flow diagram depicting an interrelated implementation of a process 300 for graphically representing the content of a file containing metadata. At 310, a selection of a file, such as a computer file or program code, containing metadata is received. At 320, model objects are obtained. As above, there is a root model object that all other model objects can be reachable from. Moreover, each model object may have a set of property-value pairs assigned Thereafter, at 330, the metadata of the selected file is associated with the obtained model objects. At 340, each model object is associated with a corresponding hierarchical tree node. At 350, the hierarchical tree nodes are displayed, e.g., in a tree structure. As with FIG. 2, the process 300 permits a user to easily understand the semantical structure of the file contents since the content is represented in a tree structure.

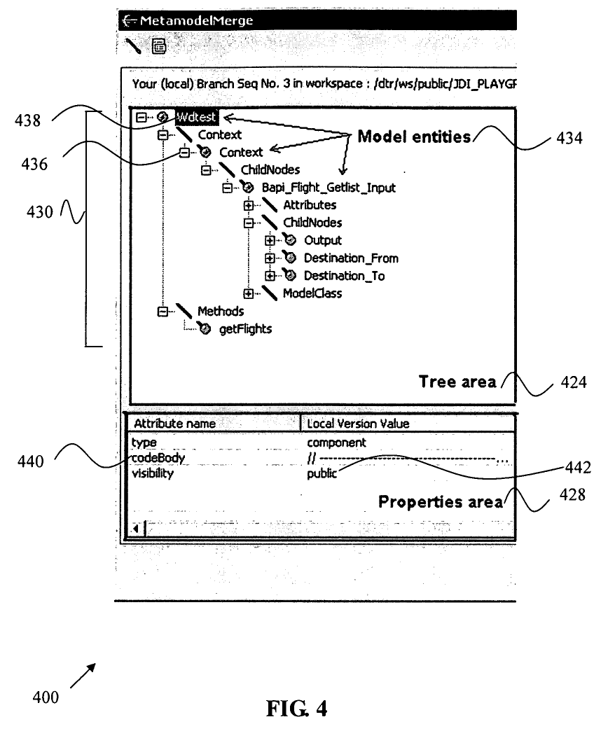

FIG. 4 depicts an example of a graphical user interface 400 that can result from the processes of FIGS. 2 and 3. The graphical user interface 400 includes a tree area 424 and a properties area 428. The tree area 424 provides a graphical representation of a model 430. In this case, the model 430 is a tree structure of model objects 434 that represents exactly an underlying file. Each model object 434 occurs as a tree node 436. Relationships between model objects occur as tree nodes, as well. A tree node 436 is an atomic unit of visualization and each tree node 436 holds at least one model object 434. The model objects 434 include a root model object 438, e.g., Wdtest, that all the other model objects 434 can reach. A selected model object, such as Wdtest, may be framed or highlighted to indicate its selection. The properties area 428 includes the properties (attributes) 440 and values 442 of the selected model object (Wdtest). Here the selected model object has attributes 440 of type, codeBody and visibility. The values 442 include, e.g., component and public. For example, the attribute “type” has a value of “component.”

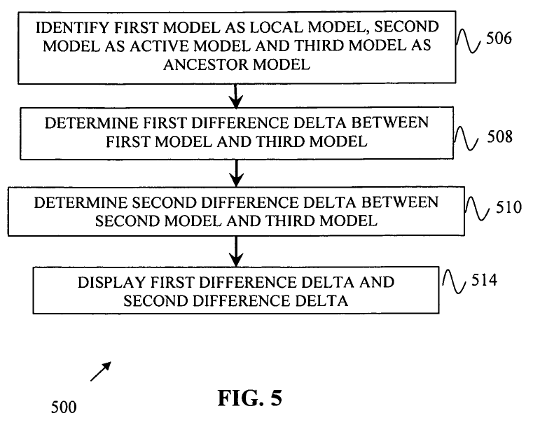

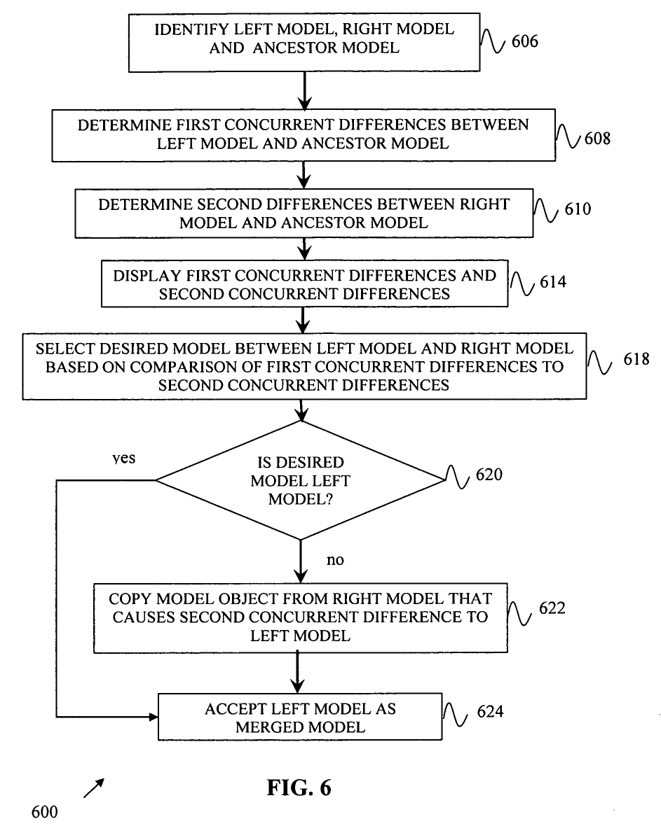

FIG. 5 is a flow diagram depicting an implementation of a process 500 for graphically representing differences between the content of files (or file sets) containing, for example, metadata for use during a merge process. Generally, three models are utilized to determine and represent the differences between the content of files containing metadata, although fewer or more models may be utilized. Each of the models result from the content of a file (or file set), such as metadata. The file or file set may be retrieved from a DTR versioning system or local hard disk.

The models may include a left model, a right model and an ancestor model. In a check-in conflict scenario, for example, the left model may be called “local” and the right model may be called “active”. The left (or local) and right (or active) models may be considered concurrent models because either may be designated the active model. The ancestor model is generally the latest common ancestor of the concurrent models.

The result of a comparison between models may be referred to as difference deltas. Each difference delta concerns a model object of one or both of the compared models. The difference deltas may be classified as applicable (or not), and if classified as applicable whether to be automatically applied (i.e., mergeable). Applicable deltas also may be classified by the way they behave when being applied.

If, for example, two models, such as the left (local) model and the ancestor model, are compared to determine the differences between them and the result of the comparison is determined to be to be applicable, then when each difference delta of the result is applied, the model object corresponding to the difference delta in both the left (local) model and the right (active) model are made equal by changing the model object in the left (local) model, which contains the result of the merge.

The difference deltas that are not applicable may be referred to as pseudo difference deltas, which may occur, e.g., where a difference between the ancestor model and the left (local) model is the same as a difference between the ancestor model and the right (active) model. For example, such a difference may occur where a model object X has been added in the left (local) model beneath a model object Y and the same addition occurred in the right (active) model. As such, there is actually no difference between the concurrent models with respect to the model object X beneath the model object Y. But since it typically is important for a user to know that the same change occurred in both models, the user may be made aware of this fact by graphically highlighting the same change to both models.

As noted above, applicable difference deltas may be classified as automatically applied (i.e., mergeable) or not, and if not, then the user needs to determine interactively whether to apply or merge the difference delta during the merge process. An automatically applied (or mergeable) difference delta may result where a concurrent difference delta results from a difference between the ancestor model and only one of the concurrent models (i.e., not both of them) without any conflict with difference deltas between the ancestor model and the other concurrent model. Thus, if an automatically applicable difference delta occurred in the right (active) model, then the delta will be applied, but if the automatically applicable difference delta occurred in the left (local) model, then the delta will not be applied. A set of settings controlling the specific properties of a difference delta, e.g., whether to be automatically applied (or mergeable) may be provided to the user. These settings can set by the user on, e.g., a preference page.

Difference deltas that are not automatically applicable (or mergeable) can occur where, e.g., a model object X is deleted on one model (e.g., the left model), while only a property of the model object X was changed on the other model (e.g., the right model). In this case, there is a conflict between the concurrent difference deltas as they both concern the same model object (i.e., model object X). Thus, for such difference deltas, the user needs to interactively decide during the merge process whether or not to accept the difference delta.

During the merge process, the difference deltas may be graphically represented or visualized differently in a graphical user interface, such as in a conflict viewer and/or in a properties area. For example, a color, style and icon may be used to visually distinguish each class of difference deltas.

As noted above, applicable difference deltas may also be classified by the way they behave when being applied, such as positive deltas, negative deltas, exchange deltas, property deltas and reordering deltas. Positive deltas occur when the right (active) model has an additional model object that does not exist at the corresponding location in the left (local) model. If this type of delta is applied, the positive delta will insert this additional model object into the corresponding location in the left (local) model. The model object to be inserted may be graphically or visually marked to indicate to the user the difference. If the positive delta is applied, then the model object exists in both models (i.e., the left model and the right model). In this case, the model object may be marked in both models and may be connected via a link.

Negative deltas can occur when the left (local) model has a model object that is missing at the corresponding location in the right (active) model. If this type of delta is applied, the negative delta will delete this model object in the left (local) model. The model object to be deleted may be graphically or visually marked to indicate to the user the difference. If the negative delta is applied, then the model object is deleted from the left (local) model, so it will no longer be visible to the user.

Exchange deltas can occur when the right (active) model has a model object that is different than the model object in the corresponding location in the left (local) model. If this type of delta is applied, the exchange delta will exchange the model object in the left (local) model with the model object in the corresponding location in the right (active) model. The model object to be exchanged exists in the left (local) model and the exchanging model object exists in the right (active) model. Both of these model objects may be graphically marked and connected via a link.

Property deltas can occur when the value of a property of a model object is different between the left (local) and right (active) models. If this type of delta is applied, the property delta will change the property in the left (local) model by copying the value from the right (active) model to the left (local) model. These model objects may be marked and connected via a link.

Reordering deltas can occur when the order of model objects is different between the left and right models. If this type of delta is applied, the reordering delta will change the order of the model objects by copying the order of the model objects in the right (active) model to the left (local) model. The model objects involved may be marked and connected via a link.

As seen in FIG. 5, the process 500 for graphically representing the difference deltas between the models, starts at 506, where a first model, a second model and a third model are identified as a local model, an active model and an ancestor model, respectively. As mentioned previously, the ancestor model is typically the latest common ancestor of the concurrent models, in this case the first model and the second model. At 408, the difference delta between the first (local) model and the third (ancestor) model is determined. Likewise, at 510, the difference delta between the second (active) model and the third (ancestor) model is determined. As described previously, the difference deltas can include pseudo difference deltas, automatically applicable (or mergeable) difference deltas and applicable (or mergeable) difference delta that are not automatically applicable. Also, noted above, applicable difference deltas may include positive deltas, negative deltas, exchange deltas, property deltas and reordering deltas. Next, at 414, the difference deltas are displayed, e.g., by graphically representing each difference delta in a graphical user interface, such as in a conflict viewer (e.g., a tree area) and/or in a properties area. For example, a color, style and icon may be used to visually distinguish each type (or class) of difference deltas.

FIG. 6 is a flow diagram depicting an implementation of a process 600 for merging files containing metadata. As with FIG. 5, three models are utilized—a left model, a right model and an ancestor model. Each of the models result from the content of a file (or file set), which may be retrieved from a DTR versioning system or local hard disk. In the process 600, at 606, a left model, a right model and an ancestor model are identified.

As noted above, if any two models are compared, then the result is a set of difference deltas in each of the two compared models. The difference deltas between each of the concurrent model (left and right model) and the ancestor model, referred to as concurrent differences, are used to create a merged model that is the result of the merge process. Thus, at 608, the concurrent differences between the left model and the ancestor model are determined, and at 610, the concurrent differences between the right model and the ancestor model are determined.

Then, at 614, the concurrent differences are displayed, e.g., by graphically representing each difference delta in a graphical user interface, such as in a conflict viewer (e.g., a tree area) and/or in a properties area. A color, a style and an icon may be used to visually distinguish each type (or class) of current differences.

In the merge process described herein, the left (or local) model will be the merged model at the end of the process, but in other implementations of the merge process the right model may be the merged model. The left model is changeable because it may be persisted in a file or files on the local hard disk rather than in a remote file or remote files in the DTR. The differences between the ancestor model and each of the concurrent models depict how the concurrent differences originated and also help to explain each concurrent difference. Thus, at 618, based on the displayed current differences, a user can select either the left model or the right model as the desired model. At 620, if, based on the concurrent difference, the left (or local) model is the desired model, then, because the left model by default is the merged model, nothing remains to be done, and the difference may be considered resolved and the process proceeds to 624. On the other hand, at 620, if, based on the concurrent difference, the left model is not the desired model (i.e., at 618 the right model was selected as the desired model), then, at 622, that portion of the right model that causes the concurrent difference is copied to the left model so that there is no actual difference anymore. Once the copying is complete, the difference may be considered resolved and the process proceeds to 624. At 624, the left model is accepted as the merged model.

The difference deltas between a left model and an ancestor model can used for decorators in the left model. The difference deltas between a right model and an ancestor model can be used for decorators in the right model. The difference deltas between a left model and a right model can be used for frames and links between the left and the right model. In some variations, navigation from delta to delta and the application mechanism works only with the last (i.e., most recent) set of difference deltas.

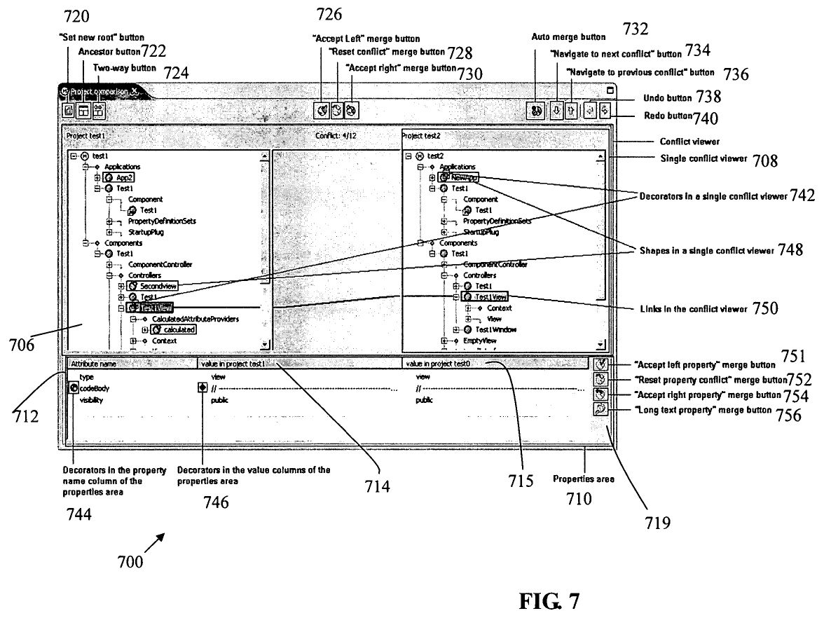

FIG. 7 depicts a graphical user interface 700 of a merge tool frame work that can be used to merge files or file sets containing, for example, metadata. The graphical user interface 700 includes a left conflict viewer 706 and a right conflict viewer 708, both of which are used to visualize associated models. The left conflict viewer 706 is associated with a left (local) model. The right conflict viewer 708 is associated with a right (active) model. The graphical user interface 700 may also have a top conflict viewer (not shown), which may be associated with an ancestor model. As described above, the left (local) model, the right (active) model, and the ancestor model display the contents of files or file sets using model objects formed in a tree structure that can result from the process of FIGS. 2 and 3 and graphically depicted in FIG. 4. The concurrent differences or difference deltas between the left model and ancestor model and the right model and the ancestor model can be determined and displayed according to a process such as the one described with reference to FIG. 5.

The graphical user interface 700 also includes a properties area 710 for displaying all properties of a currently selected node and associated model object, which in this case is “Test1View”. The properties area 710 may include an attribute(or property) name column 712, a first value column 714, which can be associated with the left (local) model), a second value column 716, which can be associated with the right (active) model, and a third value column (not shown), which can be associated with an ancestor model.

With continued reference to FIG. 7, the difference deltas (or concurrent differences) may be visually distinguished by first decorators 742, second decorators 744, third decorators 746, shapes 748 and links 750. The first decorators 742 occur in the conflict viewers 706, 708. The first decorators 742 occur at tree nodes and show that the model content these nodes are associated with has been changed with respect to the corresponding node of the ancestor model. Different types of first decorators 742 show whether a node has been added or the content of a node has been exchanged or if property values have been changed The first decorators 742 correspond to the third decorators 746, which may occur in the value columns 714, 715 of the properties area 710. The third decorators 746 in the value columns show that the value of the associated property in the selected node has been changed with respect to the value of the same property in the corresponding node of the ancestor model.

The second decorators 744 may occur in the property name column 712 of the properties area 710. The second decorators 744 denote a difference delta of the current property displayed, which in this case is “codeBody”. The second decorators 744 correspond to shapes 748 and links 750. The shapes 758 are visualizations of a difference delta concerning only one node in one conflict viewer, e.g., either the left conflict viewer 706 or the right conflict viewer 708. The links 750 are visualizations of the connection between two shapes, one for a node in the left conflict viewer 706 and one for a node in the right conflict viewer. All difference deltas concerning a node in the left conflict viewer 706 and a node in the right conflict viewer 708 can be visualized by two shapes 748 for the nodes and a link 750 between them.

The graphical user interface 700 also includes a top line tool bar 718 that contains, for example, toggle buttons, such as a “set new root” button 720, an ancestor button 722, a two-way button 724, an “accept left” merge button 726, a “reset conflict” merge button 728, an “accept right” merge button 730, an “auto merge” button 732, a “navigate to next conflict” button 734, a “navigate to previous conflict” button 736, an undo button 738, and a redo button 740. The “set new root” button 720 can be used for tree structured models and associated with an action to set an inner node of each tree in the left model and the right model (and ancestor model) as a new root for all trees in order to view a part of the model instead of the entire model. The ancestor button 722 can be used to show and hide the top conflict viewer (not shown) with the ancestor model. If the ancestor button 722 is activated, e.g., my moving a cursor over the button with in input device such as a mouse and clicking the left mouse button, then the top conflict viewer and associated ancestor model are shown above the left conflict viewer 706 and the right conflict viewer 708. Moreover, the third value column 716 is shown in the properties area 710 if the button 720 is activated. The two-way button 724 can be used to switch to a two-way merge mode. In this mode, the common ancestor is not shown and can not be shown. The properties area 710 will show only the first value column 714 and the second value column 715, and decorators 742, 746, 748 are not displayed.

The “accept left” merge button 726 can be used to resolve a current conflict, i.e., there is a difference delta associated with a tree node/model object. As described above with reference to FIG. 6, a conflict may be resolved by accepting the left model object of the currently selected node. As the left model is the result model, nothing is changed. Similarly, the “accept right” merge button 730 can be used to resolve the current conflict. This resolution of the current conflict can be accomplished by accepting the right model object of the currently selected node. As the left model is the result model, the right model element is copied into the left model. The “reset conflict” merge button 728 can be used to un-resolve the current conflict. As the left model is the result model, the original content of the node in the left model is restored if necessary.

The auto merge button 732 can be used to perform a specific action for all auto-mergeable deltas. The “navigate to next conflict” button 734 can be used to navigate to the next conflict of interest in a forward direction. Similarly, the “navigate to previous conflict” button 736 can be used to navigate to the next conflict of interest in a backward direction. A user can set up a preference page specifying whether all difference deltas are navigated, whether only applicable difference deltas are navigated, or whether the difference deltas requiring user interaction are navigated. The undo button 738 can be used for undoing the last merge action, while the redo button 740 can be used for redoing the last merge action.

The graphical user interface 700 also includes a properties tool bar 719 that contains, for example, an “accept left property” merge button 751, a “reset property conflict” merge button” 752, an “accept right property” merge button 754, and a “Long text property” merge button 756. The “accept left property” merge button 750 can be used to resolve the current property conflict, which can be done by accepting the left value of this property of the currently selected node. As the left model is the result model, nothing is changed. Similarly, the “accept right property” merge button 754 can be used to resolve the current property conflict, which can be done by accepting the right value of this property of the currently selected node. As the left model is the result model, the value of the property of the right model object is copied into the left model object. The “reset property conflict” merge button 752 can be used to un-resolve the currently selected property conflict. As the left model is the result model, the original value of the property on the left side is restored if necessary. The “long text property” merge button 756 can be used to open a modal dialog, perform a textual merge with arbitrary result (of type String) and set the difference delta to resolved.

Thus, as can be seen in FIG. 7, files, such as XML files containing metadata, are represented in a tree structure, which makes the semantical structure of the file clear to the user. The tree structure provides an abstract view to the user and offers the user a better view of the metadata that has changed and the means by which the metadata has changed. By displaying meta data differences in an abstract and graphical way, a user does not need to read the files directly to determine the differences. Now differences between the content of files can be shown as markings (e.g., decorators, shapes and links) in the trees and between trees.

Also, with the framework described in FIG. 7, the various types of difference deltas can be depicted. For example, if a model object is deleted in the left conflict viewer, then it is not existing in that conflict viewer any more, but that same model object is still existing in the right conflict viewer, so it is framed to reflect this condition. However, if the model object is changed in the left conflict viewer, it and the same model in the right conflict viewer are decorated to reflect this condition. As another example, if a property value in a model object has been changed in the left conflict viewer then this model object together with the corresponding one on in the right conflict viewer is framed and both are connected via a link. As yet another example, if a model object in the left conflict viewer has been exchanged by another one of a different type, then the model object together with the corresponding one in the right conflict viewer is framed and both are connected via a link. Thus, in addition to a clearer and more intuitive display of the metadata of a file, even the differences between the data trees of different files can be depicted in a way that is understandable to users of the semantical knowledge of the underlying model that is used to calculate the differences. Each difference (difference delta) can be explained by a piece of text in an additional view in order to make the differences even clearer and to explain to the user who has performed this change, i.e., whether the application provider changed the application or the customer changed it.

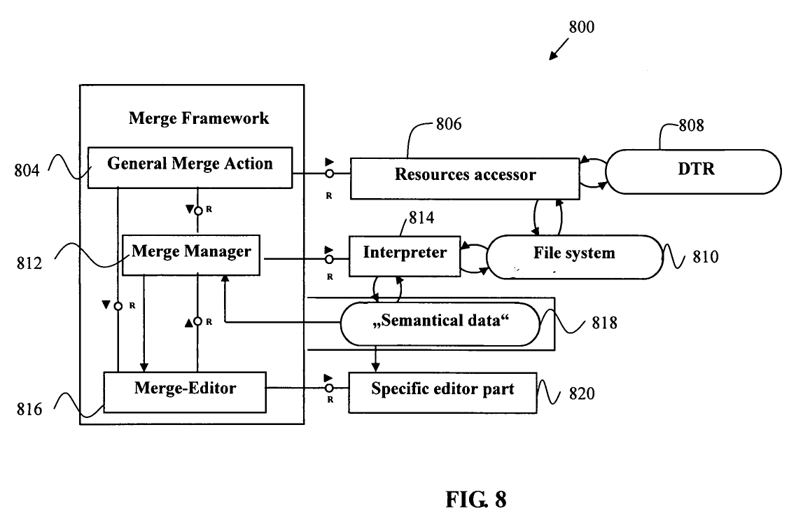

FIG. 8 is a block diagram of the architecture of a merge tool framework 800 that can be used to merge files or file sets containing metadata. When an instance of the merge tool 800 starts, e.g., by user interface triggered actions, the general merge action module 804 initializes the resources accessor module 806, the merge manager module 812 and the merge-editor module 816. The resources accessor module 806 retrieves all necessary resources (e.g., the various versions of the file or file sets) from the DTR 708 versioning system and stores them to the file system 810 (e.g., a local hard disk) as a starting point for the merge process. This process of retrieving the resources and storing the resources may be referred to as a download. The merge manager module 812 manages the merge process and causes the interpreter module 814 to read from the file system 810 the content of a files or file sets after the resources accessor module 806 writes to the file system 810. The interpreter module 816 builds up the semantical data 818 of the resources (files or file sets), e.g., the meta data structures (model objects) read from the file system 810. The merge-editor 816 displays the semantical data 818 of the resources (e.g., in the manner described in connection with FIG. 7) and executes merge operations. Each time an atomic merge operation is performed, i.e., resolution of a difference delta corresponding to a particular model object, the merge editor 816 or the specific editor part module 820 executes the operation. In response to a merge operation, the interpreter module 814 via the merge editor 816 and the merge manager 821 changes the semantical data 818 and writes the changed semantical data 818 back to the file or file sets in the file system 810, which may be referred to as the merged files or file sets. The resources accessor module 806 then retrieves the merged files or file sets from the file system 810 and checks (or stores) them in to the DTR 708 versioning system. This process may be referred to as an upload.

In some variations, integrity static constraints can be observed during model merge processes. A static integrity constraint is a statement that has to be fulfilled by all states of the model to be consistent. A violation of such a constraint can have negative implications.

With such implementations, for example, the description (or the part of the model) of each field of the structure contains the position of the field inside the structure explicitly as an integer number. The numbers of the positions of all fields have to build up a sequence starting with 0 and ending with the number of fields decremented by 1. Each of these numbers have to occur as a position exactly once.

A sample model of a structure is illustrated as follows:

TABLE 1

| Field name | Position |
|---|---|
| Field 1 | 0 |
| Field 2 | 1 |
| Field 3 | 2 |

If you delete the field “Field 2” from Table 1, then the description of the table looks like this:

TABLE 2

| Field name | Position |
|---|---|
| Field 1 | 0 |
| Field 3 | 1 |

With such a deletion, on one hand the field “Field 2” has been deleted but on the other hand the position numbers of all following fields (“Field 3” in this case) are decremented by one. As a result, there are two changes in the model description of the structure that are inseparable in order to keep the document consistent during the merge process. A difference between concurrent versions of a file can be referred to as a “conflict.” For each conflict the merge tool offers (generically) the possibility to accept either side, independently.

Independently handling the conflicts of Tables 1-2 may yield problems:
1. If for the first conflict the left side is accepted (meaning the deletion is rejected) and for the second conflict the right side (meaning Field 3 has position 1), then the result is the following:

TABLE 3

| Field name | Position |
|---|---|
| Field 1 | 0 |
| Field 2 | 1 |
| Field 3 | 1 |

In Table 3, Position “1” occurs twice in the list.
2. If for the second difference the left side is accepted (meaning Field 3 with position 2) and for the first one the right side (meaning the deletion of “Field 2” is accepted), then the result is the following:

TABLE 4

| Field name | Position |
|---|---|
| Field 1 | 0 |
| Field 3 | 2 |

In Table 4, there is a gap in the sequence of position numbers (i.e., Position “1” is missing).

Both situations in Tables 3 and 4 violate the static integrity constraint from above. Only if both differences are kept together during the merge process the resulting description of the structure is consistent. As a result, in meta models there are usually integrity constraints enforcing multiple differences between two documents not to be handled, separately.

Depending on several properties (for example file type) a mechanism dependent on the currently used meta model can be plugged generically into a merge tool that groups so-called “atomic” differences together that must not be handled separately. These groups are called “transactional units”, as all of their members are handled uniformly in exactly the same; so a merge operation acts like a transaction does.

One of the differences of a transactional unit is to be designated as its representative. This one is the only one to be displayed in the merge tool. And for this difference only a merge operation can be performed (“choose left side version” or choose right side version”). But all differences of this group are treated exactly as its representative is treated in this case. That means if the left side for the representative is chosen then the left side is chosen for all differences in the unit. The same holds for the right side.

In the merge tool if a difference being a representative of a transactional unit is selected, then one can switch to a special mode such that all members of the unit are displayed, but nothing else. Then everything you do is meant to be applied for this unit only. You may easily switch back to the usual tool behavior.

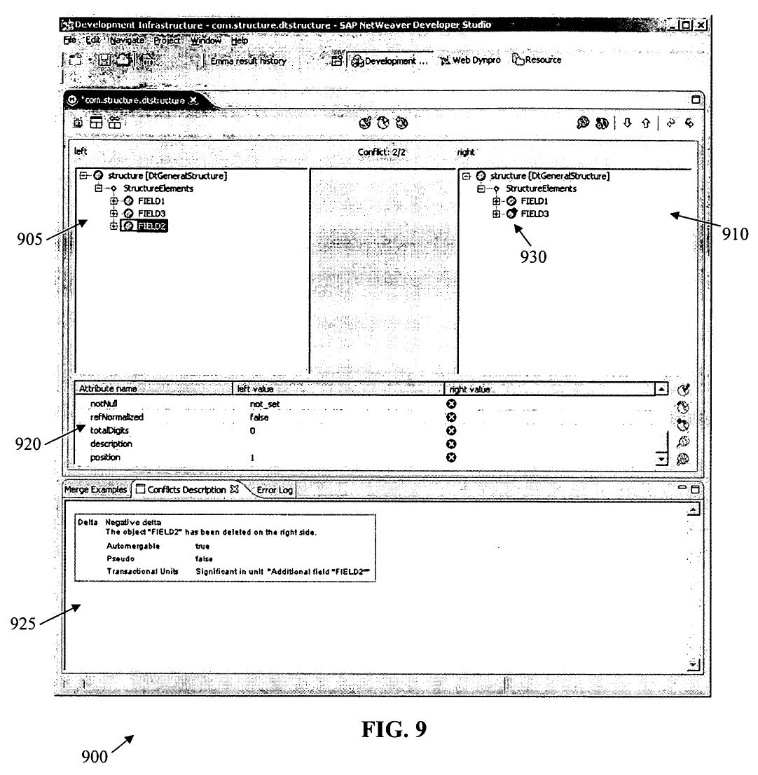

FIG. 9 illustrates a first view of a graphical user interface 900 of a merge tool frame work that can be used to merge files or file sets containing, for example, metadata. The graphical user interface illustrates transactional units 905, 910 from two different versions of a file. In the transactional unit 905 of the left version, Field “2” 915 is highlighted indicating that it contains a conflict. In an attribute window 920, information characterizing attributes of Field “2” are displayed. In a conflict description window 925, information characterizing a conflict associated with Field “2” is displayed. Field “3” 930 on the right version includes a graphical depiction indicating that it has been modified although it is not significant in a transactional unit. In some variations, members of a transactional unit that are not significant may be displayed differently (e.g., grey vs. black color, etc.).

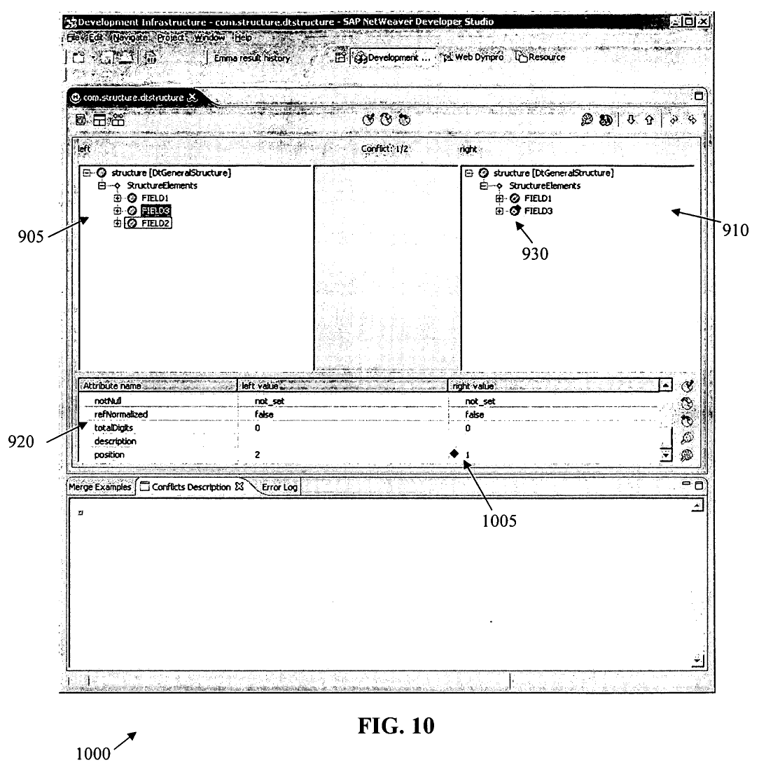

FIG. 10 illustrates a second view 1000 of the graphical user interface 900 of FIG. 9. In this view, Field “3” 930 has been selected which results in attribute information associated with Field “3” 930 being displayed in the attribute window 920. In particular, the red diamond 1005 indicates that the position of Field “3” was changed on the right version (by means of deletion of “Field 2”).

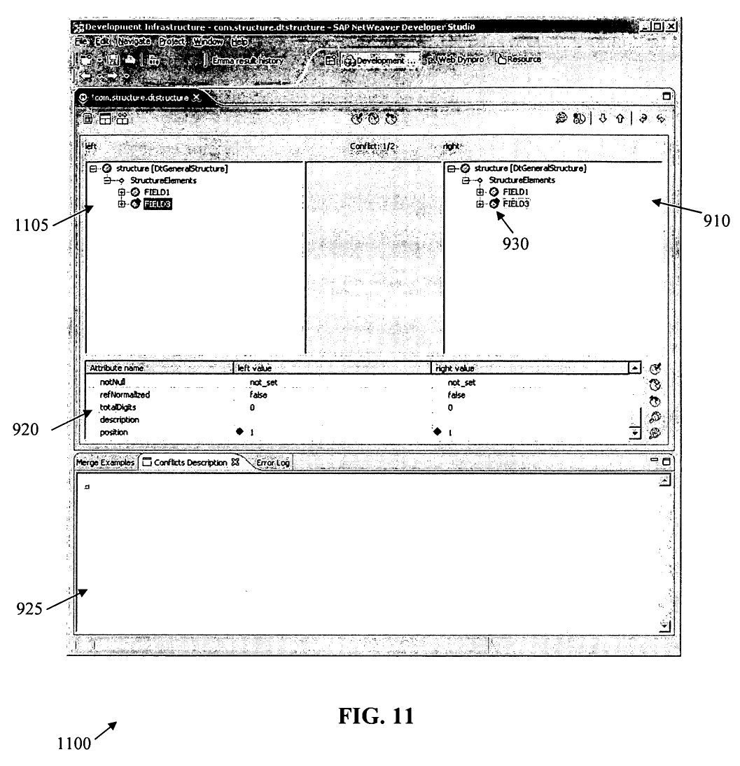

The left file version is the resulting version, that is, it is the version to be checked in after the complete merge process has been finished. If the left side version is to be accepted, then the transactional unit 905 illustrated in FIGS. 9 and 10 comprises the final version. However, if the right side version is accepted, the members of transactional unit 910 illustrated in FIGS. 9 and 10 are copied to the left side version as illustrated in transactional unit 1105 of FIG. 11.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, steps in a flow diagram may be replaced with other steps, additional steps may be added, some steps optionally may be removed, and/or steps may be performed in a different order, or in parallel, relative to the order depicted. Accordingly, other embodiments are within the scope of the following claims.

What is claimed is:

1. An article comprising a machine-readable medium tangibly embodying instructions that when performed by one or more machines result in operations comprising:
identifying at least two transactional units during a merging of at least two versions of a file, the transactional units including members requiring uniform handling to avoid violation of one or more static integrity constraints;
receiving user-generated input selecting one of the transactional units in a first version of the file; and
copying the members of the selected transactional unit to a second version of the file.

2. An article as in claim 1, further comprising:
identifying differences that require uniform handling to form a transactional unit.

3. An article as in claim 1, further comprising:
displaying each member of a transactional unit in response to user-generated input.

4. An article as in claim 3, wherein the displaying comprises:
visually differentiating each member associated with a conflict

5. An article as in claim 1, further comprising:
displaying information characterizing a conflict among members in different transactional units.

6. An article as in claim 5, wherein the displayed conflict information characterizes a conflicting attribute.

7. An article as in claim 1, wherein each file version includes at least one transactional unit.

8. A computer-implemented method comprising:
identifying at least two transactional units during a merging of at least two versions of a file, the transactional units including members requiring uniform handling to avoid violation of one or more static integrity constraints;
receiving user-generated input selecting one of the transactional units in a first version of the file; and
copying the members of the selected transactional unit to a second version of the file.

9. A method as in claim 8, further comprising:
identifying differences that require uniform handling to form a transactional unit.

10. A method as in claim 8, further comprising:
displaying each member of a transactional unit in response to user-generated input.

11. A method as in claim 10, wherein the displaying comprises:
visually differentiating each member associated with a conflict

12. A method as in claim 8, further comprising:
displaying information characterizing a conflict among members in different transactional units.

13. A method as in claim 12, wherein the displayed conflict information characterizes a conflicting attribute.

14. A method as in claim 8, wherein each file version includes at least one transactional unit.

15. An apparatus comprising:
means for identifying at least two transactional units during a merging of at least two versions of a file, the transactional units including members requiring uniform handling to avoid violation of one or more static integrity constraints;
means for receiving user-generated input selecting one of the transactional units in a first version of the file; and
means for copying the members of the selected transactional unit to a second version of the file.

16. An apparatus as in claim 15, further comprising:
means for obtaining a plurality of model objects to represent a plurality of metadata of a selected file;
means for associating each obtained model object with a corresponding one of a plurality of tree nodes; and
means for displaying the associated tree nodes in a tree structure.

17. An apparatus as in claim 16, further comprising:
means for obtaining a plurality of model objects; and
means for assigning a plurality of attributes to each obtained model object, wherein each attribute comprises a property and a value.

18. An apparatus as in claim 15, further comprising:
means for obtaining a first model of a first file, a second model of a second file and a third model of a third file;
means for determining one or more differences between the first model and the third model;
means for determining one or more differences between the second model and the third model; and
means for displaying the first model, the second model and at least one determined difference.

19. An apparatus as in claim 18, further comprising:
means for displaying a first tree containing a plurality of hierarchically arranged model objects of the first model;
means for displaying a second tree containing a plurality of hierarchically arranged model objects of the second model; and
means for displaying at least one determined difference.

20. An apparatus as in claim 19, further comprising:
means for obtaining a plurality of model objects of the first model to represent a plurality of metadata of the first file;
means for associating each obtained model object with a corresponding one of a plurality of tree nodes;
means for arranging the associated tree nodes corresponding to a structure of the plurality of metadata of the first file; and
means for displaying the arranged tree nodes in a tree structure.
